(19) United States
(12) Patent Application Publication
(10) Pub. No.: US 2002/0178386 A1
(43) Pub. Date: Nov. 28, 2002

(54) Modem and a controller thereof

(76) Inventor: Su-Chen Wang, Keelung (TW)

Correspondence Address: BIRCH STEWART KOLASCH & BIRCH, PO BOX 747, FALLS CHURCH, VA, 22040-0747, US

(21) Appl. No.: 09/861,702

(22) Filed: May 22, 2001

(51) Int. Cl. G06F 1/26; G06F 1/28; G06F 1/30

(52) U.S. Cl. 713/300

(57) ABSTRACT

A modem and a controller allow a personal computer and its related peripherals to receive electric signals to automatically power on or power off the personal computer and its related peripheral and to execute software of a specific function through communication with the computer via I/O ports. When the personal computer and its peripherals are powered-on, the controller can execute software through communication with the computer via I/O ports. Without a computer, the controller can independently execute a specific function based on the internal program setup and electric signals received from the detector. When the controller communicates with the computer, electric signals can be transferred from a remote location, to remotely control a synchronous connection and the on/off of an apparatus. The controller may also utilize the existing resources of the modem and the computer to automatically perform certain functions.

### BACKGROUND OF THE INVENTION

The present invention relates to a modem and a controller thereof, and more particularly to a means that uses applications preset up in a personal computer or the controller of the present invention could be as well as (a) inputs at keys on an operating panel of the means, or (b) any determination made by a control software of the means, or (c) an electric signal sent by a remote detector of the means, or (d) an electric signal sent via a communication medium or a modem to control non-periodical but automatic powering on or off of the personal computer and the related peripherals thereof whenever it is necessary.

A personal computer has become very popular in people's daily life. It is able to provide many different functions, such as plotting, calculating, image processing, etc., through various kinds of applications set up in the computer. When the personal computer is connected to a modem, it is even possible to connection to a remote location to communicate with external environments.

When a currently available personal computer is powered on, a power supply immediately supplies required power to all components of the computer. Meanwhile, a personal computer includes various interfaces, random access memory (RAM), read-only memory (ROM), interface chips, etc. surrounded a central processing unit (CPU), as well as other internal peripherals, such as the hard-disk drive, the monitor, etc. All these numerous and complicate components included in the hardware of the personal computer must work at the same time under orders from the CPU, even when the personal computer is in a sleep mode. In the case a computer and its peripherals have to maintain powered on over a long period of time to run software from time to time, there must be numerous components of the computer and of the peripherals involved in the continuous operation of the computer. Such continuous power-on condition of the computer would result in quick aging of the components thereof and cause serious damage to the whole computer and its peripherals.

Currently, the following means are adopted to solve the above-mentioned problem with the continuous use of a personal computer:

1. An operator is assigned to watch the computer, and detecting and sensing devices are used to discover targets to be detected. The detected targets are recorded one by one and any obtained information is entered into the computer for data processing. And then, the processed data is sent to a remote location via a modem. This way necessitates an operator to watch the computer day and night. In the event the targets to be detected appear at irregularly intervals, for example, from three to seven days or from ten to thirty days or even more, it would be completely inefficient and unreliable to watch the computer and record the appearance of the targets. Moreover, a real-time recording of the detected targets is not possible in this way of monitoring.

2. No operator is assigned to watch the computer and the modem, the computer, and the peripherals are left in the power-on state for as long period as needed. Meanwhile, various detecting devices are used and any detected data is automatically sent to the computer for real-time recording and processing. The processed data is then sent to a remote location. This second way of monitoring the computer might be acceptable if such monitoring extends over only a short period of time. When the computer and the peripherals are left to the power-on state for a prolonged time, it would inevitably cause quickly aged internal components and increased failure rate thereof.

### SUMMARY OF THE INVENTION

It is therefore a primary object of the present invention to provide a highly efficient and reliable means that is capable of real-time recording and effectively meets the requirement of continuous powering on of a computer and its peripherals on a long-term basis while solving the problem of quickly aged internal components and increased failure rate caused by the prolonged power-on state of the computer.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a structure diagram showing different elements involved in the operation of the present invention;

FIG. 2 shows the present invention is in the form of an independent control means and connected to a personal computer and other related apparatuses;

FIG. 3 shows the present invention is built in a modem to form an independent unit and is connected to related apparatuses; and

FIG. 4 shows the present invention is built in a personal computer and is connected to related apparatuses.

### DETAILED DESCRIPTION OF THE PREFERRED EMBODIMENTS

The following is a brief description of the functions of elements involved in an operation of the present invention. The parenthesized number before each described element is a reference numeral thereof:

(1) Operating and display panel: This is provided for inputting data via a keyboard, displaying current status, modifying input data, etc.

(2) Radio-frequency (RF) reception/emission unit:

This is provided to receive electric signals sent by a RF emission/detecting unit, or to emit a control signal to a RF reception/power supply unit or other similar reception unit.

(3) Wired input unit: This is provided to receive related electric signals sent by a wired input unit.

(4) Telecommunication interface: This is a conversion interface to enable telecommunication equipment, personal computer and modem to transmit data.

(5) Primary chip-configured unit: This is provided to control the input, output, communication, operation, storage, flow, debugging, etc.

(7) PC on/off control device: This is a device for controlling the supply or disconnection of power from an external power supply to a personal computer. The control may be implemented via cables or RF.

(8) Modem on/off control device: This is a device for controlling the supply or disconnection of power from an external power supply to a modem. The control may be implemented via cables or RF.

(9) Power-supply control device for externally connected apparatuses: This is a device for controlling the supply or disconnection of power from an external power supply to other related peripherals, such as DC digital camera, video recorder, CCD (charge-coupled device) lens, etc. The control may be implemented via multistage cables or RF.

(10) Operating power supply: This is the power supply to different components of the present invention for the operation thereof.

(11) Representative multistage RF-emission/detecting unit: This is provided for emitting, sensing, detecting, and transmitting signals.

(12) Representative multistage wired-transmission/detecting unit: This is provided to sense, detect and transmit signals.

(21) Representative multistage RF-reception/power supply unit: This is provided for RF control of other multistage reception and power supply.

(13) Modem.

(14) Main control unit of the present invention.

(15) Personal computer (PC).

(16) Multistage peripherals: A video camera is illustrated as an example.

(17) Peripherals: A video recorder is illustrated as an example.

(20) External power supply: This is provided for supplying power needed by different circuits of the present invention, the personal computer and other related apparatuses. The power source may be alternating current or an uninterrupted power supply (UPS).

(30) Communication media or devices: The media for communication with external environment may be a general telephone line, an optical cable, an electric cable, and the devices may be a modem, a network card, etc.

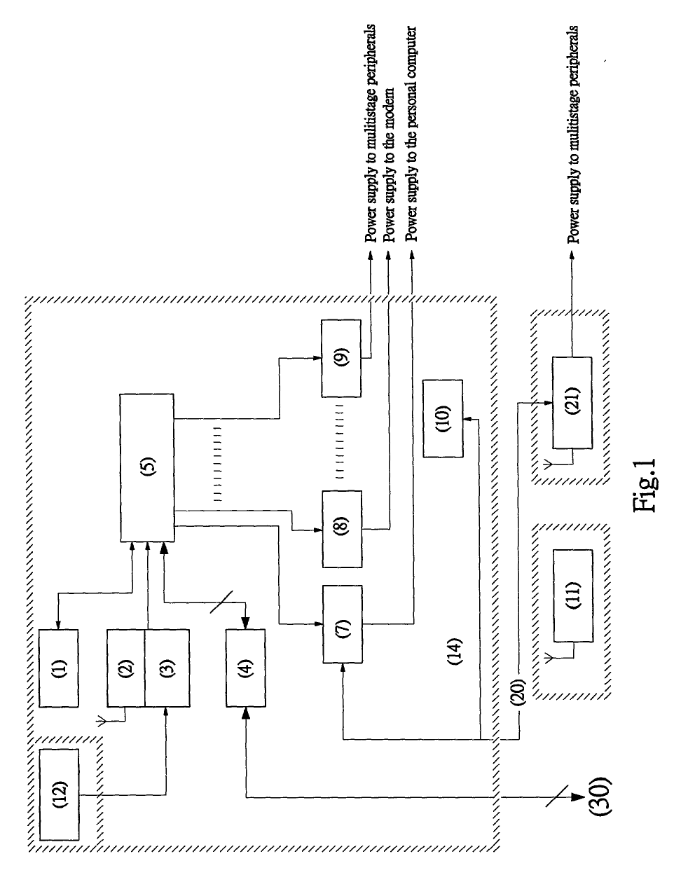

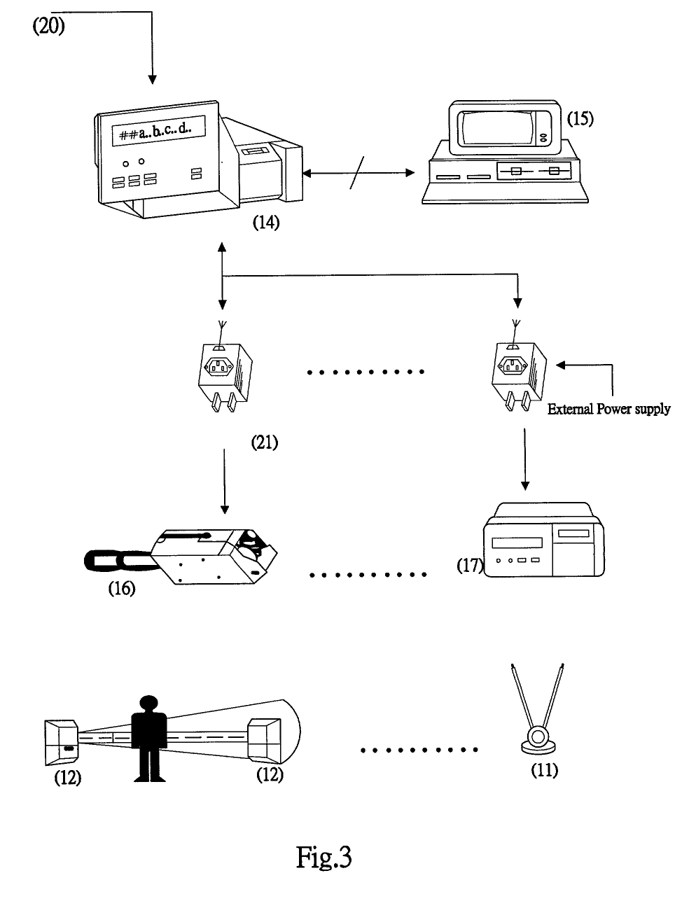

Please refer to FIGS. 1 and 3 that shows the present invention is incorporated into a modem to form a main control unit 14. The operating and display panel 1 is connected to the main control unit 14 to serve as an outer panel thereof. The relevant wiring of the modem and the main control unit 14 are integrated into one body. Data transmission between the modem/the main control unit 14 and the personal computer 15 and other multistage peripherals 16, 17 and the connection of the present invention to a remote location is possible via internal bus and communicating ports 4. The power on/off control devices 7, 9 in the main control unit 14 or the RF reception/power supply unit 21 for controlling the power supply to the personal computer/multistage peripherals, etc. may be a socket-type device or a wireless remotely-controlled socket-type device at a remote location to facilitate control of the power supply to the personal computer and other multistage peripherals.

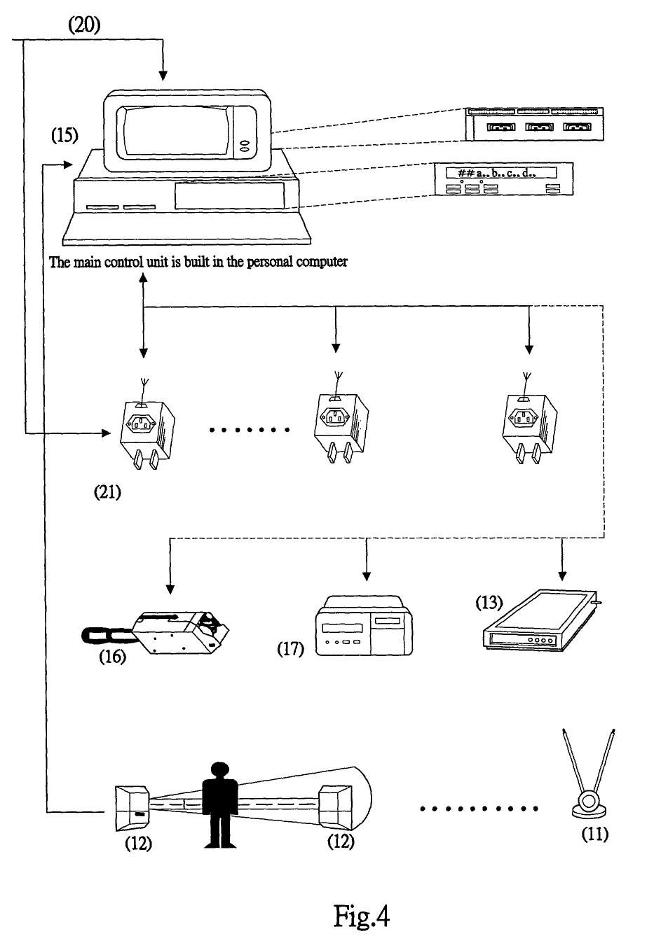

Please refer to FIGS. 1 and 4 that shows the present invention is incorporated into a personal computer and connected to other related apparatuses. In this case, the operating and display panel 1 is connected to the personal computer 15 to serve as an outer panel thereof. Other components of the present invention are either connected to a main board of the personal computer by way of add on card, or directly provided on the main board through proper planning. The main control unit 14 communicates with multistage peripherals, for example, a video camera 16, or with other representative multistage peripherals 17 by directly using the internal bus thereof and through communicating ports. Wherein, the internal PC power on/off control device 7 of the present invention for controlling power supplied to the personal computer, and the power on/off control devices 8, 9 or the RF reception/power supply unit 21 of the present invention for controlling power supplied to the modem/multistage peripherals, etc. may be a socket-type device or a wireless remotely-controlled socket-type device at a remote location to facilitate control of power supply to the personal computer and other multistage peripherals.

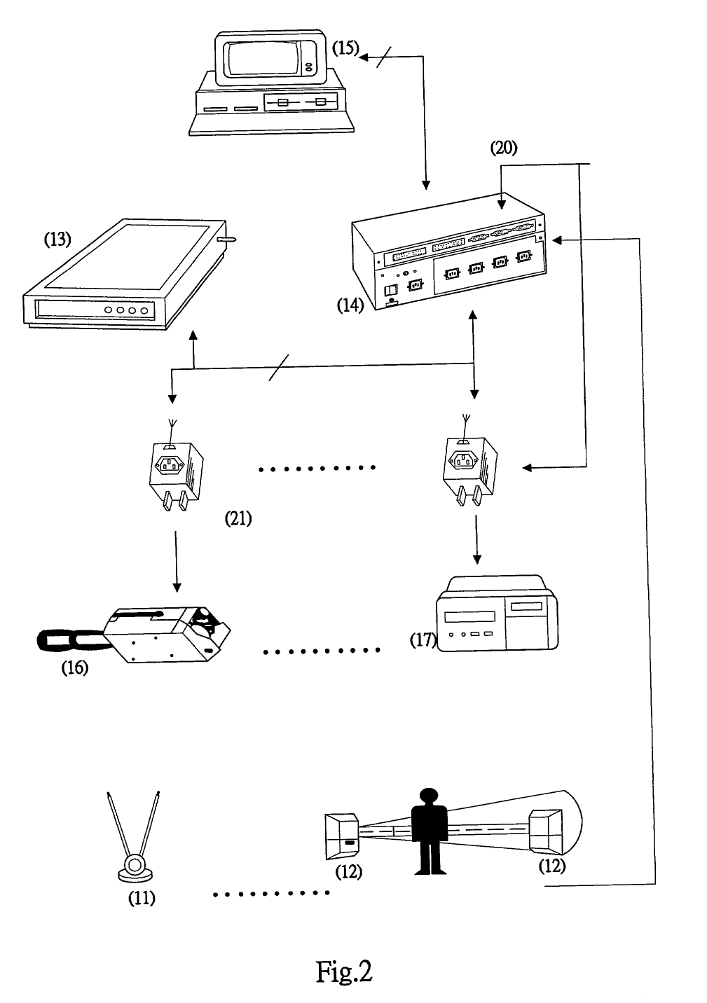

FIG. 2 shows the present invention is in the form of a separate and independent control means 14 and is electrically connected to personal computer, modem, and other related apparatuses. That is, the present invention in this case is a hardware structure completely separated from the personal computer and the modem.

The unique practicability and the workable objects of the present invention will now be described in more details as below.

Please refer to FIG. 1. In general situation, the external power supply 20 supplies only the operating power supply 10 needed by the present invention, and no power is supplied to the personal computer 15 and the multistage peripherals 16, for example, a video camera, and the peripherals 17, for example, a video recorder. That is, when the personal computer and its peripherals are in a standby mode, only the main control unit 14 of the present invention is powered to operate independently. Moreover, a circuitry of the present invention may be provided on a chip microprocessor. In this structure, the present invention includes components much simpler than that for a personal computer. Such simplified structure enables the present invention to be more reliable than the personal computer in the case of operating over a prolonged time period. Moreover, it is possible to force the present invention into the sleep mode when it is in the general standby state. In the sleep mode, the present invention stops providing an internal operating clock. Since the components of the present invention almost consume no power in a standby state, as compared with the complicate components of a computer that must work at the same time, it is possible for the present invention to operate continuously for a long time in good condition.

To enable a two-way communication between the present invention and the personal computer, it is necessary to include the present invention in a personal computer system configuration. Thus, when the present invention is first used, a user needs to connect it either as FIG. 2, 3 or 4, and to initialize the internal primary chip-configured unit 5 according to the signal mode, so that it closes the circuits of the PC power on/off control device and the representative multistage RF-reception/power supply unit 21 for the external power supply 20 to supply power to the computer 15. Thereafter, the application exclusive for the present invention is set up in the hard disk drive through the existing input system of the personal computer, and then the RF-emission/detecting unit 11, the RF-reception/power supply detecting unit 21, the wired input unit 3, the power-supply control devices 9 for other externally connected apparatuses, etc. are assigned according to the requirements of software, in order to set up stages, types, and other related hardware parameters and configurations or movement modes. In addition, two-way data transmission of related data between the present invention and the personal computer is made through the I/O ports on the personal computer, the primary chip-configured unit of the present invention, and the telecommunication interface 4. Moreover, the present invention is also able to connect the personal computer to external environments through electric signals sent by the communication media or devices 30 and the applications set up in the personal computer, so that a remote control via the present invention is possible.

In conclusion, it is known that (1) although a computer provides tremendous resources, it includes numerous complicate components that consume a large amount of power and tend to become aged quickly and failed at increased rate if the computer is continuously in the power-on state for a prolonged time period; on the other hand, the present invention is practical and highly reliable for use and does not have the problems of quickly aged and frequently failed components even if the present invention is in a continuously power-on state for a prolonged time period; and (2) the numerous resources that could be provided by the computer, such as the producing of special sound or musical effects, the memorizing or recording of images and pictures, the mathematical operation, etc., all still could be provided through the present invention; the present invention is therefore a means that utilizes existing computer resources to provide practical, creative, and added values.

The present invention may be implemented as the following apparatuses that are sufficient to prove the practicability and workability of the present invention:

1. The present invention is implemented as a security and anti-theft monitoring apparatus:

Mode A: The computer and other related apparatuses are set up according to the internal software options and configurations. The computer, the modem, and the related apparatuses may be supplied or not supplied with power. Only the present invention is in the standby mode.

Mode B: When a remote RF detector detects any unauthorized invasion, the detecting unit immediately sends via cables or RF a signal code to the main control unit of the present invention for the same to turn on the personal computer and the externally connected apparatuses that would then enter an anti-theft control program to do real-time video recording, to make warning through pictures or sounds, to store images, to display icons, or to make on-line connection and image transfer via the modem. Alternatively, an identification code sent by the detector is checked so as to send information about the time and position at which the security apparatus is actuated to the computer to make real-time records, or the modem is used to send the information to a remote location, or the modem or the RF-emission unit is used to sent out a control code to other neighboring main control units of the same level to enable multi-directional, cascade-connected synchronous work.

Mode C: After the above-mentioned related information has been processed in the computer, the preset data, options and parameters may be downloaded to the main control unit to determine whether the computer and the externally connected apparatuses should be powered off after a proper delay to avoid repeated powering on within a short time or be powered on continuously.

Mode D: The computer and other related apparatuses are in the working state.

Mode E: If the detector detects any unauthorized invasion, it immediately sends a signal to the main control unit of the present invention for the same to turn on related apparatuses in accordance with the preset programs (by emission to a power supply receptor at the other end to turn on the power supply switch), or to interrupt the current work and enter into the anti-theft control program to complete the works as described in Mode B and Mode C.

2. The present invention is implemented as a non-attended showing apparatus:

Mode A: The present invention is in a standby state. Since the detector of the present invention may be a non-touch sensor, the present invention and the whole set of related hardware thereof may be transparently isolated from the external environment.

Mode B: When the sensor detects a touch of it by someone, it immediately sends a signal to the main control unit for the same to turn on the personal computer, so that the computer enters into a non-attended showing application to show a series of sounds or images, or to show products via multiple media. Alternatively, a control code is sent via the modem or the RF-emission unit to a neighboring main control unit of a lower level to enable multistage chain work.

Mode C: The subsequent movements are the same as that described in the above Mode C for the first implementation of the present invention.

3. When the present invention is implemented as a recording apparatus, such as a fax machine, an answer machine, a video recorder, etc.

Mode A: The present invention may be in the standby state.

Mode B: When the present invention detects an electric signal entered via a communication medium, it enters into a fax/answer machine application depending on the preset software, and emits a pilot identifying sound to represent a fax machine, an answer machine, a video recording machine, or a connection of line before receiving a fax, a message or an image or connecting the line. Alternatively, a pre-recorded voice, image or document may be automatically played according to the state that actuates the detector. It is no need to manually turn on the answer machine to listen the recorded messages. All the required memorizing devices and the conversion of voice could be obtained from the existing resources on the computer.

Mode C: After the related information has been processed, it is sent back via the I/O ports and the present invention. After the two-way communication between the computer and the present invention, the present invention powers off the computer. Since the related simple messages have been sent back to the present invention from the computer, message about, for example, in-coming calls could still be displayed on the operating panel of the present invention even if the computer has been powered off.

The present invention has been described with some preferred embodiments thereof and it is understood that many changes and modifications in the described embodiment can be carried out without departing from the scope and the spirit of the invention that is intended to be limited only by the appended claims.

What is claimed is:

1. A modem and a controller thereof, comprising:
an option of input/display panel for operating purpose;
a reception/emission unit for receiving electric signals from a detecting unit and emitting electric signals to a remote reception/power supply control unit;
a telecommunication interface for connection of said modem and said controller to external electric communication apparatuses and a personal computer;
a reception/power supply unit for receiving signals sent by said controller;
a primary chip-configured unit for controlling output/input, communication, mathematical operation, storage, flow, debugging and the like; and a detecting unit for sending or emitting electric signals to a reception unit of said controller;
whereby said modem and said controller thereof function as a control means to work with a personal computer or a modem and other related apparatuses thereof to either automatically power on or power off said personal computer, said modem and said related apparatuses based on determination by a control software, electric signals transferred via one or more communication media or electric signals received from a detector, or simply transmit electric signals in order to automatically execute software of specific function or to transfer and receive signals to and from a remote location, to connect said personal computer to an external network, or to implement a connection through remote control.

2. The modem and the controller thereof as claimed in claim 1, wherein said input/display panel is a option may provided with keys via which an operator is able to directly control a power supply to said personal computer, said modem and said other related apparatuses, or to set up, modify, update and diagnose an integral software for said controller, or to input modes or configurations for relevant operations, or to display related messages and states.

3. The modem and the controller thereof as claimed in claim 1, wherein said control means may have differently planned internal software program and setup and may work with said personal computer or said modem to function as a security anti-theft monitoring apparatus, a non-attended showing unit or a fax machine/answer machine/video recording unit; and said control means may also work independently without working with said personal computer or said modem to function as a part of a security anti-theft monitoring apparatus, a part of an answer machine/recording unit.

4. The modem and the controller thereof as claimed in claim 1, wherein said detecting unit may be a wireless (such like RF-emission,IR,Laser, ultrasonic) structure, or a wired-connection or contact structure, or a combination thereof; and said detecting unit may be a multistage or a single-stage expandable apparatus.

5. The modem and the controller thereof as claimed in claim 1, wherein said reception/power supply unit may be a multistage or a single-stage expandable apparatus; and said reception/power supply unit may be wire-controlled or wireless-controlled, or a combination thereof.

6. The modem and the controller thereof as claimed in claim 1, wherein said input/display panel for operating purpose or said reception/emission unit or said telecommunication interface or said power supply unit may be integrated into said personal computer, depending on actual need, to form an integral unit that functions as an independent apparatus.

7. The modem and the controller thereof as claimed in claim 1, wherein said input/display panel for operating purpose or said reception/emission unit or said telecommunication interface or said power supply unit may be integrated into said modem, depending on actual need, to work with said personal computer and said detecting unit to function as a security anti-theft monitoring apparatus, or to work without said personal computer to form a part of a security anti-theft monitoring apparatus.

8. The modem and the controller thereof as claimed in claim 1, wherein said input/display panel for operating purpose or said reception/emission unit or said telecommunication interface or said power supply unit may be an independent and integral control means, depending on actual need, to separate from said modem and said personal computer.

9. The modem and the controller thereof as claimed in claim 1, wherein said primary chip-configured unit, when working with said telecommunication interface and said personal computer or said modem, has the on-line and network ability, and is able to handle from a remote location the setting up, modifying, updating and diagnosing of the modes and configurations of related movements, the displaying of messages, the processing of signals, and the transferring of voices and images, and has the function of cascade connection of remote hardware and software.

10. The modem and the controller thereof as claimed in claim 1, wherein said modem may be an internally or an externally connected dial modem, cable modem, asynchronous digital subscriber line (ADSL) modem or a network card that enables connection of the personal computer to a network.
